(19) United States
(12) Patent Application Publication
(10) Pub. No.: US 2026/0107952 A1
(43) Pub. Date: Apr. 23, 2026

(54) PASTA MACHINE WITH HEATED DIE

(71) Applicant: DEFRANCISCI MACHINE COMPANY LLC, Melbourne, FL (US)

(72) Inventors: Leonard Joseph DeFrancisci, Melbourne, FL (US); Joseph Lawrence DeFrancisci, Great Falls, MT (US)

(21) Appl. No.: 19/382,069

(22) Filed: Nov. 6, 2025

Related U.S. Application Data
(63) Continuation-in-part of application No. 17/859,344, filed on Jul. 7, 2022, now abandoned.

(51) Int. Cl. A21C 11/16; G05B 13/02; G05B 19/05; H05B 1/02

(52) U.S. Cl. CPC A21C 11/16; G05B 13/0265; G05B 19/05; H05B 1/0227; G05B 2219/13144

(57) ABSTRACT

A pasta machine includes an adaptive die-heating system configured to preheat a pasta forming die prior to extrusion. The system comprises a heater, a blower, temperature sensors, and a programmable logic controller (PLC) operatively coupled to an artificial-intelligence (AI) module. The PLC controls heater power and airflow while the AI monitors temperature feedback to predict, correct, and refine the heating process. Each die is identified by serial number or recipe data, and the AI retrieves and updates a die-specific heating profile based on historical performance. The system automatically adjusts energy distribution between radiant and convective sources to achieve uniform temperature equilibrium. Over successive runs, the AI learns optimal heating parameters to reduce energy usage, minimize startup waste, and ensure consistent pasta quality from the first extrusion cycle. The invention provides a self-optimizing, data-driven improvement over fixed-parameter preheating systems.

### CROSS-REFERENCE TO RELATED APPLICATIONS

This application is a continuation in part of U.S. Patent Application Ser. No. 17/859,344, filed on Jul. 7, 2022, which is a continuation of U.S. patent application Ser. No. 15/849,968, filed on Dec. 21, 2017, and are hereby incorporated herein in their entireties.

### TECHNICAL FIELD

The present invention relates to the field pasta extruding machines, and more particularly, to a pasta extruding machine having a die heating system.

### BACKGROUND

Pasta machines for domestic and commercial use have been known for many years. Such machines typically mix a dough composed of flour, commonly semolina or bread wheat, and water to achieve the desired consistency, and then extrude the dough through a die having a plurality of orifices shaped to produce pasta of a selected form. The extrusion die, usually constructed of metal, plays a critical role in determining the geometry, surface texture, and uniformity of the resulting pasta strands.

In conventional pasta production systems, the extrusion die remains at ambient temperature when the machine is first started. As the dough is pressed through the die, mechanical friction and heat transfer from the surrounding equipment gradually raise the die temperature to a steady-state condition suitable for consistent extrusion. However, this warming process can take several minutes, particularly in commercial extruders having large brass or bronze dies with significant thermal mass. During this initial warm-up period, the pasta emerging from the die tends to vary in dimension, texture, and moisture content, resulting in non-uniform or deformed strands. Operators typically discard the first several batches until the die reaches an equilibrium temperature conducive to proper extrusion characteristics.

The resulting waste not only increases material and labor costs but also interrupts continuous production and quality control. Moreover, in automated systems, the inconsistency during startup can cause clogging of downstream cutters or conveyors and may necessitate manual cleaning. Attempts to accelerate die heating have included pre-running the machine without dough, using external heaters applied to the die body, or circulating hot water or air near the extrusion area. These approaches, however, often lack precise temperature control, are inefficient in energy consumption, or require significant operator intervention.

Accordingly, there remains a need in the art for improved pasta production systems that can rapidly and efficiently bring the extrusion die to an optimal operating temperature, maintain that temperature during production, and thereby reduce or eliminate startup waste. Further improvements are also desirable to integrate such temperature control into automated or computer-controlled pasta production environments, enabling consistent pasta quality and improved process efficiency.

### SUMMARY

The present invention provides a system and method for preheating a pasta extrusion die prior to installation in a pasta extruder, thereby improving product uniformity, reducing startup waste, and increasing production efficiency. In contrast to conventional systems that rely on gradual die warming during initial extrusion or manual heating while mounted to the extruder, the invention enables the die to be brought to a target operating temperature before use, under precise and automated control.

In one aspect, the invention provides a die preheating system comprising a hood or enclosure configured to receive the pasta extrusion die. The hood defines an internal heating chamber in which heated air or radiant heat is applied uniformly to the die surfaces. A blower and heater are arranged to direct controlled heat flow through the chamber. A programmable logic controller (PLC) governs the operation of the blower and heater based on temperature feedback from one or more sensors positioned within the hood. A variable frequency drive (VFD) may be used to adjust the blower motor speed and thereby regulate the air flow rate and heat distribution. The PLC executes stored control logic to manage the heating sequence, including ramp-up, dwell, and cooldown phases, until the die reaches a target temperature suitable for extrusion.

The system further includes a user interface, such as a human-machine interface (HMI) on the extruder control panel or a network-connected tablet, for displaying real-time temperature, fan speed, and heating duration. The operator may select or modify heating settings directly through the interface. The control system may be integrated with the extruder's recipe management database such that each die, identified by a unique serial number, is associated with a stored heating profile defining temperature setpoints, airflow parameters, and timing. When a die is selected for production, the corresponding parameters are automatically retrieved and executed by the PLC.

In another embodiment, the invention incorporates artificial intelligence (AI) or machine learning functionality to further enhance precision and automation of the preheating process. The AI module receives sensor data, die identification data, and historical heating results to train predictive models of heat-up behavior for different die types and materials. Using this learned information, the AI module can dynamically adjust heater power, fan speed, and heating duration to achieve faster and more uniform temperature distribution. Over successive production runs, the AI continuously refines the stored heating profiles for each die, improving efficiency and consistency without operator intervention.

The AI component may also employ reinforcement learning or other adaptive algorithms to optimize process variables in real time, minimizing overshoot, energy consumption, and time to target temperature. In some embodiments, the system recommends or automatically implements updated heating profiles in the recipe management system, allowing future operations to benefit from accumulated experience.

The invention can utilize different types of heat sources, including forced hot air or infrared radiation, depending on the specific design of the hood and desired heating characteristics. The control framework remains consistent across heating modalities, permitting the same PLC and AI software to manage airflow, power levels, and temperature feedback regardless of the heating source used.

Through these configurations, the invention provides a robust, adaptive, and automated system for preheating pasta extrusion dies prior to production. By ensuring that the die temperature is stabilized before extrusion begins, the system significantly reduces waste, improves dimensional consistency of pasta products, and enhances overall process throughput.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of a pasta production machine having a die heating system, illustrating a pasta forming die positioned within a heating hood prior to extrusion, in accordance with an embodiment of the present invention;

FIG. 2 is a partial perspective view of the pasta production machine of FIG. 1 showing the pasta forming die in a first preheating position within the hood;

FIG. 3 is a partial perspective view of the pasta production machine of FIG. 1 showing the pasta forming die being transferred from the preheating position to a second position aligned with the extruder head;

FIG. 4 is a perspective view of a pasta production machine having a die heating system in which a blower and heater assembly are positioned within a hood enclosure to direct heated air around the die, according to another embodiment of the present invention;

FIG. 5 is a perspective view of a pasta production machine having a die heating system employing an infrared heating unit positioned within the hood for radiative preheating of the die, according to another embodiment of the present invention;

FIG. 6 is a schematic of a die heating system with a programmable logic controller (PLC) and human-machine interface (HMI) for operator monitoring and control; and

FIG. 7 is a flowchart illustrating a method of preheating a pasta forming die and producing pasta using the die heating system.

### DETAILED DESCRIPTION

The present invention will now be described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

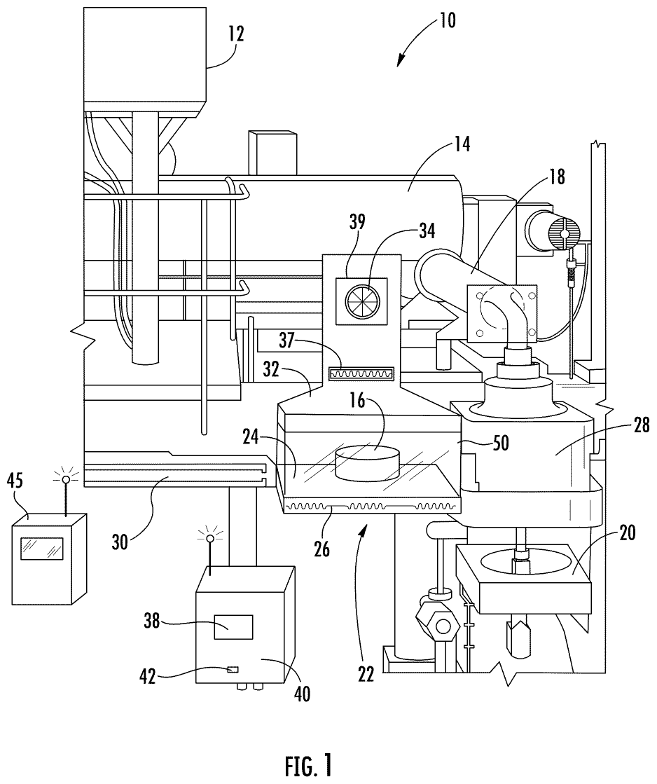

Referring to FIG. 1-7, the present invention provides a pasta production machine 10 configured to preheat a pasta forming die 16 prior to installation on an extrusion head. By warming the die before contact with dough, the invention eliminates startup variability that occurs in conventional systems that rely on incidental die heating during initial extrusion. The die heating system 22 described herein uses closed-loop thermal control integrated with digital recipe data and, in certain embodiments, artificial-intelligence optimization to provide uniform, rapid, and repeatable die conditioning.

Referring to FIG. 1, a pasta machine 10 is illustrated having an integrated adaptive die heating system 22 configured to automatically learn and control the temperature conditioning of a pasta forming die 16 before extrusion begins. The pasta machine 10 generally includes an ingredient feeder 12 for introducing measured quantities of flour, water, and optional additives into a mixing chamber 14. The mixing chamber blends and hydrates the ingredients into a homogeneous dough mass and transfers the dough to an extrusion chamber 18 where it is compressed and prepared for discharge through the pasta forming die 16.

The pasta forming die 16 is detachably mounted to a die holding plate 24 that forms part of the die heating system 22. The plate may include a conductive base, such as aluminum or copper, with embedded electrical resistance heaters 26 and temperature sensors (for example, thermocouples or RTDs) positioned near the die interface surface. In the illustrated configuration, the die 16 is placed on the die holding plate 24 while being thermally isolated from the extrusion chamber 18, thereby allowing the heating system 22 to precisely control its temperature before production starts. A removable hood 32 may cover the die 16 to retain convective heat and protect the heating environment from drafts or contamination. The hood 32 may be directly above the die 16 and have sidewalls that form a chamber 50 to completely or partially enclose the die 16. The figures are shown without a front wall for clarity.

The die heating system 22 is governed by a programmable logic controller (PLC 38) that communicates with the heaters 26, temperature sensors, and a blower 34 via dedicated power and feedback lines. The PLC 38 executes a stored heating algorithm that regulates both heater power and airflow rate to achieve a target temperature curve defined for that specific die. The heating curve includes parameters such as ramp rate, soak temperature, dwell time, and allowable overshoot. These parameters are not static but are automatically selected from a data structure linked to the serial number for the die, geometry, and mass. The geometry of the orifices on the dies are different, which may affect the heating profile for each die. For example, a thick wall macaroni die will have larger orifices than thin wall macaroni, thus will allow more flow of warm air as it is preheated.

Each pasta forming die 16 is registered in a recipe management database that stores the operational history of the die, including previous heating durations, energy consumption, and observed temperature-uniformity indices. When a die is selected for use, its record is retrieved, and the PLC 38 initializes a corresponding heating routine. If the system detects environmental deviations, such as a colder ambient temperature than in prior runs, the control algorithm adjusts heater output preemptively to maintain consistency in the overall thermal profile. This automatic compensation eliminates the need for operator recalibration and ensures repeatable preheating results.

An artificial-intelligence (AI) module 42 may operates in conjunction with the PLC 38 to refine the heating process continuously. The AI module 42 receives live sensor data throughout the heating cycle and may be configured to construct a time-temperature profile representing the actual thermal response of the die 16. The profile is compared to a predictive model previously generated for that die. When deviations occur such as slower than expected heat rise or uneven temperature distribution, the AI module 42 updates its model coefficients and sends correction signals to the PLC 38. These correction signals can modify heater duty cycles, blower speed, or dwell duration in real time. Over successive runs, the AI progressively learns the optimal control settings that achieve the desired temperature with minimal energy and overshoot.

The human-machine interface (HMI 40) connected to the PLC 38 provides visual feedback and operator access. A touchscreen or networked display shows current temperature readings at multiple points on the die, total energy usage, projected time-to-target, and an adaptive “learning confidence” indicator calculated by the AI module 42. The operator may override or approve suggested control changes, and such actions are logged by the system to enrich future learning. For instance, if an operator consistently shortens the dwell phase for a particular die type, the AI module 42 infers that this adjustment leads to acceptable readiness and automatically shortens future cycles accordingly.

During heating, the AI module 42 is configured to monitor not only the die temperature but also rate-of-change metrics such as dT/dt and second-derivative inflection points that indicate when the die approaches thermal equilibrium. The AI compares these features against its predictive models to determine the optimal moment for transition from active heating to steady state maintenance. The PLC 38 then shifts control from full-power heating to pulse-modulated holding, minimizing energy consumption while preventing heat soak or distortion of the die.

A network connection (wired or wireless) can link the pasta machine 10 to a plant-wide database, allowing multiple machines to share die-heating performance data. The AI module 42 may be configured to aggregate this data across machines, improving predictive accuracy and ensuring that the heating behavior of each die is known even when moved between production lines. This distributed-learning capability forms part of an advantage of the invention in that the heating performance of each die becomes more precise over time, independent of operator or location.

The adaptive learning and data-driven control demonstrated in FIG. 1 represent a significant advance over prior art. Earlier systems may preheat dies but rely on open-loop or fixed-time heating sequences that cannot compensate for environmental changes or die variability. In contrast, the combination of real-time temperature mapping, AI-driven prediction, and die-specific historical data yields of the present invention provides consistent uniform heating and immediate extrusion quality. The result is reduced waste, lower energy cost, and elimination of manual setup calibration.

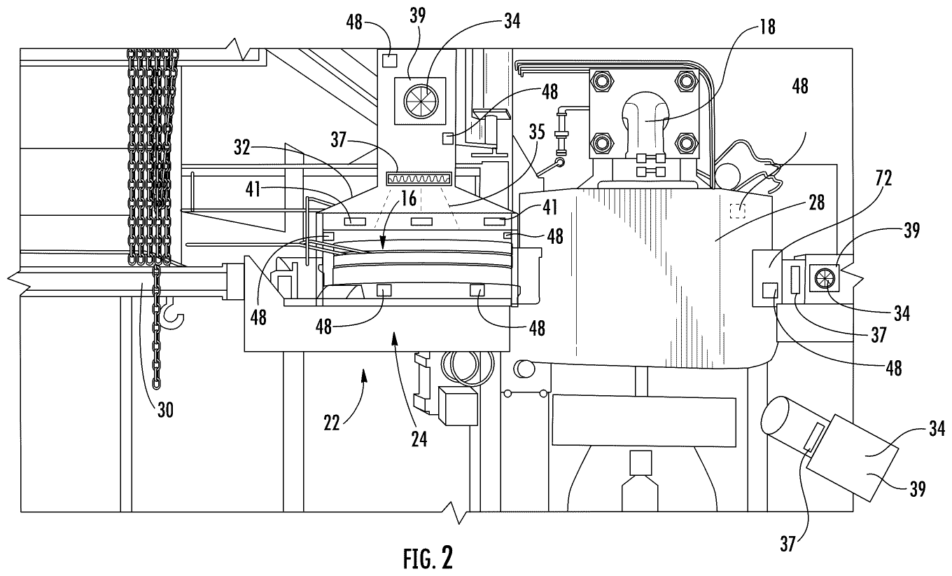

Referring to FIG. 2, a partial perspective view of the pasta machine 10 is shown illustrating the die heating system 22 in greater operational detail. The pasta forming die 16 is positioned on the die holding plate 24 within a partially enclosed heating environment defined by a hood 32. The hood 32 functions both as a thermal containment shell and as a controlled-air distribution manifold that directs heated air over the die 16. The hood 32 may include internal baffles 35 or flow-straightening vanes that channel air uniformly across the front and rear surfaces of the die 16 to ensure even convective heat transfer.

The blower 34 coupled to a heating element 37 or heat-exchange coil forces air into the hood 32 through one or more inlets. The motor 39 for the blower 34 comprises a variable-frequency drive (VFD) under command of the programmable logic controller PLC 38. The PLC 38 dynamically regulates blower speed to achieve a specified airflow rate and pressure within the hood. The heated air exits through vents 41 arranged around the periphery of the hood 32, providing continuous recirculation around the die 16 during the heating process.

Distributed within and around the hood 32 are multiple temperature sensors 48, each located at strategic positions such as the air inlet, the die face, the die periphery, and the exhaust outlet. These sensors 48 generate a thermal map of the heating chamber in real time. The sensors 48 may be thermocouples, infrared sensors, or solid-state temperature transducers, each transmitting high-frequency data to the PLC 38 and the artificial-intelligence module 42. The PLC 38 uses the data for closed-loop PID control of heater power, while the AI module 42 performs higher-level analysis to detect spatial and temporal temperature patterns that indicate heat imbalance.

During operation, the AI module 42 may be configured to continuously compare the measured thermal map to a predicted heat-distribution model stored for the specific die 16. If the measured temperature at any sensor deviates beyond an adaptive tolerance band, for example ±1.5 ° C. from the predicted value, the AI module 42 calculates a corrective action and transmits a set of adjustments to the PLC 38. These adjustments may include increasing or decreasing heater power at specific zones, modifying blower speed through the VFD, altering the orientation of internal baffles 35 or dampers within the hood 32, or extending or shortening the dwell phase of the heating cycle. The PLC 38 executes these instructions in real time, thereby restoring uniform temperature distribution.

The AI module 42 may be configured to also track the rate-of-change of temperature at each sensor 48 (dT/dt) to infer how quickly heat propagates across different regions of the die 16. From these data, it generates a numerical thermal-uniformity index and records it in the recipe management database 60 alongside the serial number for that die 16. Over successive runs, the AI builds a history of how each die responds to specific airflow and power profiles. The next time that die is selected, the AI uses the accumulated data to initialize its control variables more accurately, thereby reducing the time required to reach uniform readiness.

The human-machine interface (HMI 40) may display a live visualization of the temperature field of the hood 32, often represented as a color-graded contour map. Operators can observe how the die 16 warms and whether the AI module 42 is applying localized corrections. A log panel on the HMI 40 lists each corrective adjustment with corresponding timestamps, heater duty cycles, and fan-speed percentages. The system 10 can also project an estimated completion time, which updates dynamically as the AI refines its forecast based on real-time feedback.

A notable advantage of the FIG. 2 embodiment is that the airflow and heating conditions are not static but evolve under AI supervision to match the real thermal behavior of the die 16. Prior art preheaters employ fixed airflow or single-sensor control, assuming uniform heating, which often leads to unbalanced temperature gradients and wasted energy. In contrast, the present invention uses sensor arrays and machine-learning algorithms to achieve balanced heating without operator tuning. The capacity of the AI module 42 to learn from prior cycles allows it to anticipate the heat-up curve of the die 16, apply pre-emptive adjustments, and avoid overshoot, which are capabilities unattainable in conventional control systems.

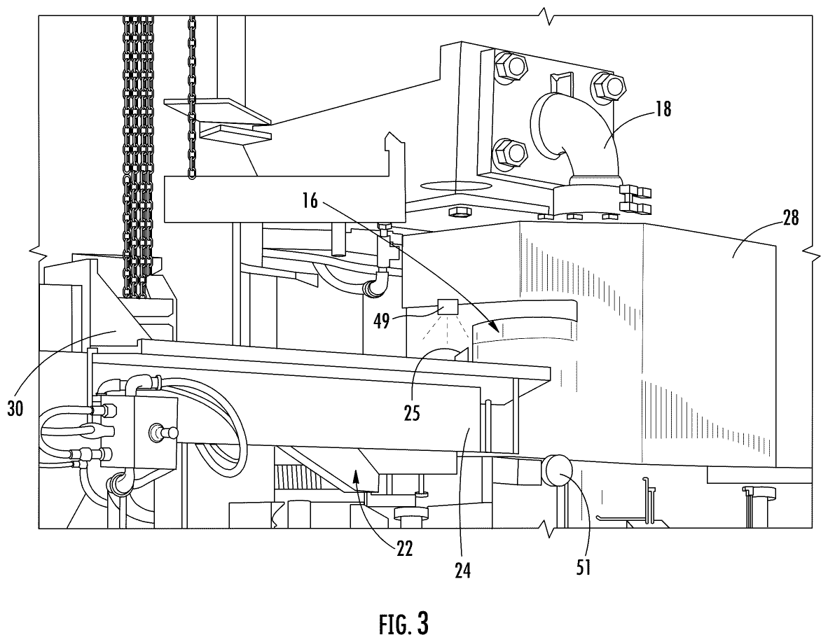

Once the AI module 42 determines that all sensors 48 within the hood 32 report temperatures within the predefined uniformity band and that the rate of change has stabilized, it flags the cycle as complete. The PLC 38 transitions from active heating to maintenance mode, reducing heater output and blower speed to a low-power state. At that point, the HMI 40 displays a “Die Ready” status, and the system 10 may automatically alert the hydraulic transfer mechanism (30, shown in FIG. 3) to position the die for extrusion.

The adaptive airflow control and spatial-learning functions depicted in FIG. 2 are central to the technical effect of the invention. By generating and continually refining a multi-dimensional thermal model of each die, the system 10 achieves repeatable, energy-efficient heating that compensates for variations in die geometry, ambient environment, or aging of the heating elements. This data-driven feedback loop converts what was formerly a manual, experience-based process into an automated, self-optimizing operation, ensuring that every pasta forming die reaches uniform readiness regardless of operator or conditions.

In addition, the adaptive airflow control discussed above can also be implemented once the die 16 has been inserted into the die holder 28. The die heating system 22 may have least one fan or blower 34 configured to direct heated air towards the pasta forming die 16 after the die has been installed in the die head or die holder 28. The fan or blower 20 can be mounted proximate to the die head and configured to blow heated air into a slot 72 of a middle portion of only the die holder 28 and configured to heat the die 16 when in the die holder 28 before the pasta dough enters the die holder 28. A controlled stream of heated air can also be continued to be directed across a face of the die 16 to maintain its temperature during production or between extrusion cycles. This configuration ensures continued thermal stability of the die 16 and reduces temperature loss after installation. As those of ordinary skill in the art can appreciate, the system 22 may be implemented with any die shape, including horizontal die shape, and a round die used herein is for exemplary purposes only and not limited thereto.

Referring to FIG. 3, once the pasta forming die 16 has been heated under the adaptive control sequence described with respect to FIG. 2, the system 10 verifies that the die 16 is thermally ready for extrusion. A hydraulic or pneumatic actuator 30 is provided to translate the die 16 between two distinct locations comprising a first heating position on the die holding plate 24 beneath the hood 3), and a second position aligned with a die holder 28 at the outlet of the extrusion chamber 18. The actuator 30 may be a linear ram, telescoping carriage, or pivoting arm assembly, each equipped with position sensors to report its state to the programmable logic controller PLC 38.

The transition from heating to extrusion is not based solely on elapsed time, but on a multidimensional assessment performed by the artificial-intelligence module 42. As the final stage of heating progresses, the AI module 42 compares real-time temperature data from the distributed sensors 48 against its learned thermal model for that die 16. It computes several convergence metrics, including the temperature variance across all sensors (ΔTmax), the rate of temperature change at each location (dT/dt), and the predicted versus actual temperature-rise curve correlation coefficient (R²).

When ΔTmax falls below a programmable threshold, for example, ±1 ° C., and the correlation exceeds a confidence value, typically 0.98 or greater, the AI module 42 concludes that the die has reached steady-state thermal equilibrium. Only upon satisfying these conditions does the PLC 38 issue a “ready-for-transfer” signal to the actuator control circuit.

The readiness verification process is critical because it eliminates the guesswork inherent in conventional preheating, where operators rely on timers or single-point thermometers. In prior systems, dies were frequently transferred too early, resulting in uneven extrusion and product waste, or left heating too long, wasting energy. Here, the AI driven verification ensures that every die is transferred precisely when its temperature profile matches the optimized model.

Upon receipt of the readiness signal, the actuator 30 disengages any alignment locks and moves the die 16 smoothly along a guided path from the heating position to the extrusion head 28. During motion, the PLC 38 may be configured to automatically enter a thermal hold mode, reducing heater output to a low-duty cycle that maintains temperature without overshoot. The hood 32 may pivot open or retract as the die 16 exits, and proximity sensors 49 confirm clearance before the ram 30 completes its stroke. In certain embodiments, a quick-connect coupling 51 provides an air-purge flow through the die apertures during transfer, preventing moisture condensation or dough residue contamination.

When the die 16 reaches the second position, a set of mechanical clamps 25 or locking pins may secure it against the die holder 28. The PLC 38 verifies engagement through limit switches or load sensors. Once confirmed, the extrusion chamber 18 begins operation, forcing prepared dough through the heated die 16. Because the internal passages of the die 16 have already achieved uniform temperature, the first extruded strands emerge with the same moisture content, density, and shape uniformity as those produced later in the run thereby effectively eliminating the “startup scrap” common in traditional systems.

Throughout this process, the AI module 42 continues to monitor residual heat flux and die-surface temperature during the first minutes of extrusion. These measurements are stored together with environmental metadata (ambient temperature, humidity, and elapsed preheat time) in a performance log associated with the serial number for the die 16. After the production run, the AI module 42 analyzes the log to determine whether the preheating sequence achieved optimal results. If deviations are detected such as a slower thermal recovery after transfer or minor overshoot during hold mode, the AI module 42 updates the stored heating coefficients for the die 16 accordingly. In this way, every cycle incrementally improves the predictive accuracy of future heating events.

In some embodiments, the PLC 38 or AI module 42 communicates the readiness and completion status to an external manufacturing execution system (MES) 45 or plant network. This allows centralized scheduling of die preheating across multiple extruders, ensuring that each die is prepared precisely when required by production flow. The readiness timestamp and temperature-uniformity report can also be archived for quality-assurance documentation, providing traceability for each batch of pasta produced.

The sequence illustrated in FIG. 3 demonstrates how the system 10 integrates intelligent sensing, predictive analytics, and mechanical actuation into a coordinated process. Rather than functioning as an isolated heater, the die heating system 22 forms a closed-loop adaptive subsystem within the broader extrusion line. By linking readiness verification to physical movement, the system 10 guarantees that extrusion begins only when all quantitative criteria for thermal uniformity are satisfied, yielding immediate, consistent pasta quality and measurable reductions in downtime and energy consumption.

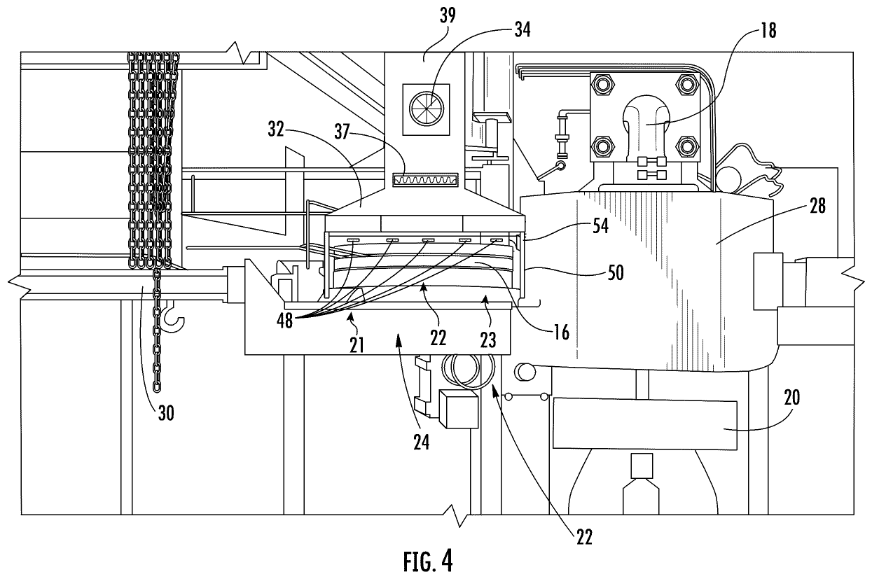

Referring to FIG. 4, another embodiment of the pasta machine 10 is shown in which the die heating system 22 provides multi-zone, spatially controlled air distribution for precise management of die temperature. The system is enclosed by the hood 32 that forms a defined heating chamber 50 surrounding the pasta forming die 16 positioned on the die holding plate 24. The hood 32 may be constructed from stainless steel with double-wall insulation to minimize heat loss and maintain a stable internal environment. The chamber 50 is designed to generate measurable, repeatable airflow patterns that can be adjusted by the controller to achieve desired heat uniformity.

Inside the hood 32 are a series of air plenums and outlet diffusers arranged around the die 16 to direct heated air to specific regions of the die surface. The air supplied to each plenum is driven by a blower 34 under control of the VFD 39 and is heated by an inline electric or gas-fired heater 37. The air channels are separated into zones (Z1, Z2, Z3), each having an independently addressable damper 54 or servo-actuated valve. By modulating the damper positions, the system 10 can vary airflow rate and temperature distribution among zones.

Each zone includes at least one temperature sensor 48 positioned near the corresponding surface region of the die 16. The sensors 48 transmit temperature readings at sub-second intervals to the PLC 38 and to the AI module 42. The PLC 38 performs local feedback control for each zone using proportional-integral-derivative (PID) algorithms to maintain set-points, while the AI module 42 performs higher-level optimization by analyzing spatial relationships among the sensors.

The AI module 42 may be configured to build and continuously updates a two-dimensional thermal-map model of the surface temperature of the die 16. This model represents how heat propagates from each zone over time. When the AI 42 detects a cold spot such as a region lagging more than a threshold (e.g., 2° C.) below adjacent zones, it generates a corrective strategy. The strategy can include increasing the airflow or heater duty cycle in the affected zone, redistributing flow from adjacent zones, or adjusting the dwell duration before readiness verification. The PLC 38 executes these corrective commands in real time.

Over successive heating cycles, the AI module 42 refines the model coefficients that describe how each zone responds to control inputs. For example, if Zone 3 consistently heats more slowly due to thicker die geometry or higher thermal inertia, the AI 42 anticipates this lag and preemptively raises the initial heater output for that zone during subsequent runs. Conversely, if a zone routinely overshoots its set-point, the AI module 42 learns to ramp power more gradually in that area. The accumulated data create a die specific spatial response signature stored in the recipe management database 60, allowing future heating cycles to start from a fully optimized configuration.

The HMI 40 is configured to display the evolving thermal map in graphical form often as a color-gradient contour image of the die surface. The operator can observe in real time how the AI 42 adjusts individual zone parameters. Each zone may display its instantaneous temperature, airflow percentage, and heater duty factor. A history tab allows playback of prior cycles, highlighting how the learning of the system 10 has reduced overall temperature variance and time-to-readiness over multiple runs.

The hood embodiment of FIG. 4 can include additional sensors such as airflow velocity sensors, pressure transducers, and infrared emissivity detectors to further refine the AI model. These auxiliary data streams enable the AI module 42 to differentiate between conductive and convective heat transfer effects and to compensate for variations in ambient humidity or back-pressure within the hood. By considering these parameters collectively, the AI module 42 is configured to produce a comprehensive multi-variable control solution that continuously drives the process toward energy efficient equilibrium.

In some configurations, the system 10 communicates with a plant-level supervisory network 45 that stores the thermal models for all dies in production. When a die is replaced or serviced, the corresponding model follows it to the next machine, preserving its learned heating behavior. This distributed-learning architecture allows the entire production line to benefit from cumulative experience gathered across machines, an advancement not achievable with standalone PLC systems.

The embodiment of FIG. 4 therefore demonstrates the critical integration of spatially resolved sensing, adaptive control, and machine-learning feedback. The system 10 does not merely maintain temperature. Instead, it actively learns the three-dimensional thermal response of each die, anticipates deviations, and corrects them automatically. The resulting temperature uniformity ensures consistent pasta texture and shape from the very first extrusion cycle, while the adaptive control minimizes energy consumption and operator involvement.

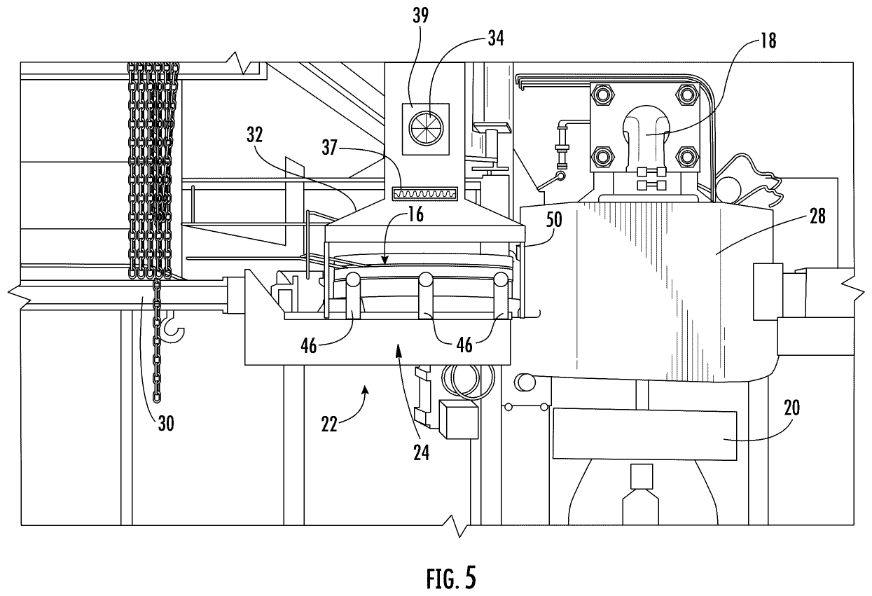

Referring to FIG. 5, another embodiment of the die heating system 22 is shown in which both convective and radiant heat sources are combined under coordinated control of the PLC 38 and the AI module 42. This hybrid arrangement accelerates warm-up of the pasta forming die 16 while preserving temperature uniformity and minimizing energy consumption.

The die 16 rests on the heated holding plate 24 within the hood 32. The blower 34 directs a controlled stream of heated air through internal plenums around the die 16 as described in FIG. 4, while a plurality of infrared emitters 46 are positioned above and/or around the die 16 to provide direct radiant heating. The infrared emitters 46 may be quartz-tube lamps, ceramic panels, or carbon-fiber elements tuned to mid-infrared wavelengths between approximately 2 μm and 10 μm—spectrally suited to rapid absorption by metallic die materials such as brass or bronze. Precise control of the heating parameters ensures that the die 16 is not subjected to thermal degradation, particularly in embodiments where the die 16 includes polymeric or composite insert materials in place of conventional bronze components.

Each infrared emitter 46 is addressable as an independent heating zone with adjustable output power. The PLC 38 drives these emitters through solid-state relays or pulse-width-modulated drivers to regulate radiant intensity. Temperature sensors 48 located near each emitter and/or at multiple points on the die surface provide feedback to the PLC 38 and the AI module 42. The PLC 38 executes a hybrid-mode control algorithm that proportionally allocates total heating energy between the convective circuit (blower+heater) and the radiant circuit (infrared emitters) based on instantaneous feedback and AI-generated optimization signals.

At the start of the cycle, the AI module 42 references the stored thermal-response profile of the die 16 from previous runs. If the model predicts a high initial heat-absorption rate, the AI module 42 prioritizes radiant heating to raise the surface temperature of the die 16 quickly. As the measured surface temperature approaches the internal target, the AI module 142 gradually shifts energy delivery toward the convective subsystem, which circulates hot air to equalize temperature throughout the die mass. This adaptive ratio that is typically expressed as a percentage of radiant-to-convective power is recalculated continuously to maintain a smooth, monotonic approach to the set-point without overshoot.

The AI module 42 evaluates real-time metrics such as surface-to-core temperature gradient, instantaneous energy-efficiency index (kWh per ° C. per kg of die mass), and projected time-to-uniformity based on derivative analysis of the heat-up curve.

From these metrics, the AI module 42 is configured to determine whether to increase or decrease radiant contribution. For example, if the gradient between surface and interior exceeds a threshold (e.g., 5° C.), the AI module 42 is configured to reduce infrared power and compensate with higher blower output to diffuse heat inward. Conversely, if the gradient collapses too slowly, radiant intensity is momentarily boosted. The PLC 38 implements these micro-adjustments every few seconds, producing an intelligently blended heating profile that neither conventional infrared nor hot air systems alone can achieve.

Over multiple runs, the AI module 142 is configured to aggregate data describing how each die geometry and material responds to different radiant-to-convective ratios. It uses this information to train a predictive model that estimates the optimal energy-mix curve for future cycles. The model continuously refines its coefficients through reinforcement learning, rewarding control strategies that minimize total power consumption and time-to-readiness while maintaining temperature variance below the allowed tolerance. As a result, the system 10 becomes progressively more efficient the longer it operates.

The HMI 40 presents the operator with a real-time display showing the current radiant/convective ratio, individual emitter outputs, blower speed, and total energy consumption. The interface 40 may also provide an “efficiency score” generated by the AI module 42, representing the comparative performance of the current run relative to historical averages. If the operator elects to modify the heating strategy such as emphasizing convective heating for moisture sensitive products, the AI module 42 is configured to record that manual input as a weighted datapoint for future learning.

The combination of infrared and hot air heating delivers distinct and unexpected technical advantages. Radiant energy rapidly warms external surfaces, shortening the time to reach activation temperature, while convective flow stabilizes internal temperature distribution. By configuring the AI module 42 to determine the ideal temporal balance between these mechanisms, the invention achieves faster and more uniform heating with up to 30-40 percent less energy usage compared to single-mode preheating systems. No prior pasta die heating apparatus known to the inventors employs an adaptive, learning-based hybrid energy-distribution framework of this kind.

The embodiment of FIG. 5 thus demonstrates another dimension of the adaptability of the invention, which includes the ability not only to control heat but to intelligently select the form of heat most efficient for the specific die and environment. This multi-modal learning approach ensures consistent readiness temperature across all die types, further reducing downtime, waste, and energy cost in industrial pasta production.

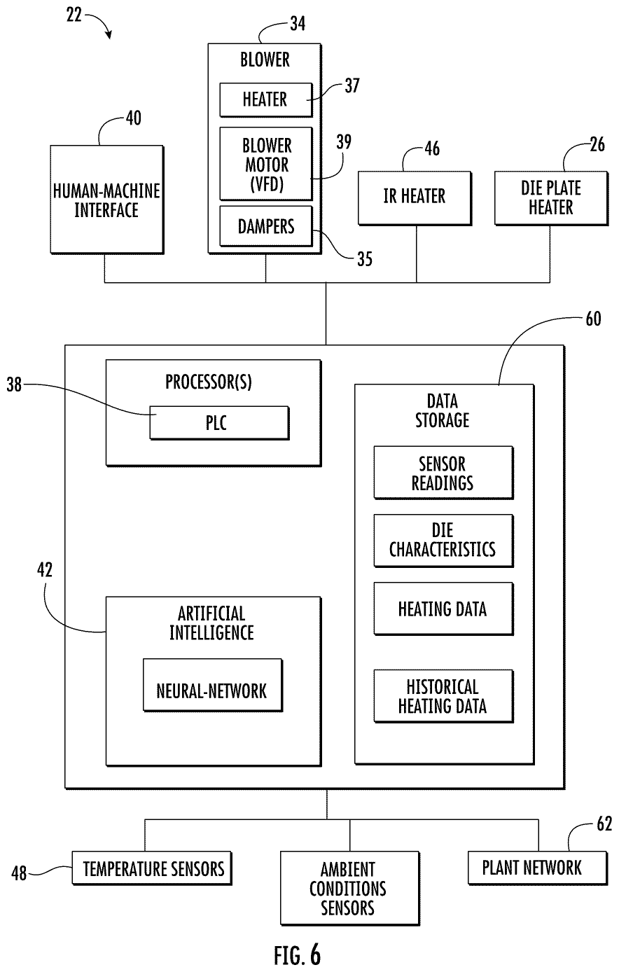

Referring to FIG. 6, the system 10 incorporates an intelligent control architecture that unifies the PLC 38, AI module 42, and HMI 40 into a closed-loop adaptive system for die heating management. This architecture transforms the preheating process from a fixed-parameter control task into a continuously learning, data-driven operation that self-optimizes over time.

The PLC 38 serves as the deterministic control layer responsible for executing low-level commands and energizing heaters (26, 37), regulating blower speed through the variable-frequency drive (VFD) 39, and temperature sensors 48. It operates in millisecond-scale control cycles to maintain precise responsiveness. Above this layer, the AI module 42 functions as the cognitive layer, performing predictive analysis, trend detection, and parameter adaptation based on data streams from the PLC 38 and historical records stored in a recipe management database 60. Communication between the PLC 38 and AI 42 comprises real-time data exchange.

The AI module 42 includes a set of machine-learning algorithms configured to model the thermal response function of the die 16. In one embodiment, a neural-network regression model receives as inputs the die identification (geometry, material, and mass), environmental variables (ambient temperature, humidity, air pressure), real-time sensor readings (temperature, airflow rate, heater current), and control-signal history (heater duty cycle, blower frequency, IR-power ratio).

The network outputs predicted temperature trajectories and confidence intervals. The AI module 42 compares these predictions with actual sensor data and adjusts internal weights using back propagation or reinforcement learning reward functions designed to minimize time-to-uniformity and energy consumption simultaneously.

The HMI 40 provides the operator with a comprehensive view of both real-time conditions and AI insights. The main display panel shows temperature plots from multiple zones, current heater and fan outputs, and a readiness indicator representing the confidence of the AI that the die 16 has reached equilibrium. Adjacent panels may present a color coded thermal map of the die surface, system efficiency metrics, and the predicted completion time. A historical dashboard allows the operator to review previous runs, including energy usage and uniformity scores, thus visualizing how the system's learning improves over time.

Operator inputs are also captured as learning data. If an experienced technician modifies a target temperature, overrides a control variable, or shortens a dwell phase, the AI module 42 records both the action and its eventual outcome. If the modification leads to faster readiness or improved uniformity, the algorithm assigns a positive reinforcement weight to that action, effectively “learning” from human expertise. Conversely, if the modification results in suboptimal heating or temperature overshoot, the algorithm assigns a lower weight. This bidirectional human-AI feedback loop enables the system to assimilate empirical operator knowledge into its predictive models—an advantage unavailable in fixed-parameter automation systems.

Over successive production cycles, the AI module 42 aggregates datasets from all dies in use and constructs a global model of die specific heating behavior. The recipe management database 60 stores this model together with key performance indicators such as mean heating time to reach equilibrium, energy consumption per cycle, variance of temperature across zones, and historical ambient-condition offsets.

The next time a particular die 16 is selected, the system loads its cumulative dataset and initializes its control parameters close to the optimal values, substantially reducing calibration time. In effect, the system “remembers” the best way to heat each individual die.

The AI module 42 may also communicate with a cloud-based analytics server 62 or plant-level supervisory control system. This connection allows aggregation of data from multiple pasta machines across a facility or even multiple manufacturing sites. The cloud service computes comparative efficiency benchmarks and automatically distributes updated model parameters back to each local AI module. As a result, learning achieved on one line such as optimized radiant-to-convective ratios for a certain die design can be propagated instantly to all other lines using the same equipment. This federated learning capability ensures that performance improvements scale enterprise wide without manual reprogramming.

During operation, the predictive model of the AI module 42 continuously updates in real time. For instance, if ambient humidity increases, altering convective efficiency, the AI module 42 detects deviations between predicted and actual heating curves and issues new set-points to the PLC 38. The PLC 38 adjusts blower speed and heater duty cycles accordingly, maintaining a consistent temperature-rise slope. The resulting corrections are logged as training examples, further refining the robustness of the model against environmental variability.

At the completion of each heating cycle, the AI module 42 may be configured to perform a post-cycle diagnostic analysis. It computes metrics such as total kilowatt-hours consumed, achieved temperature uniformity (ΔT max), and time to readiness. If these results surpass previous performance, the new configuration is promoted within the recipe management database as the preferred profile. The AI then communicates a summary report to the HMI 40, allowing the operator to verify that the system has learned and improved.

The integration depicted in FIG. 6 delivers several synergistic advantages. First, it eliminates the need for manual recalibration between production runs, as the AI automatically adjusts to differences in die geometry, material, and ambient conditions. Second, it standardizes performance across operators and machines, ensuring consistent quality regardless of user experience. Third, by combining human intuition with machine-learning adaptation, the system achieves faster preheating and lower energy consumption than either conventional PID control or purely manual adjustment. In sum, FIG. 6 illustrates the transformation of pasta-die heating from a static, open-loop process into a self-improving industrial intelligence platform.

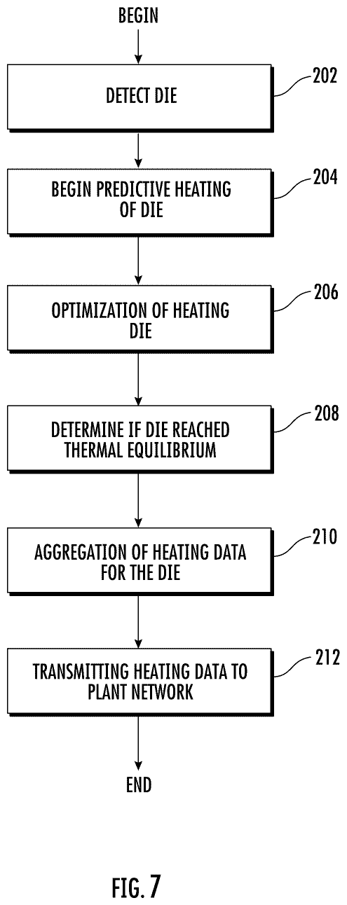

Referring to FIG. 7, a flowchart illustrates a representative method 200 of preheating a pasta forming die 16 using the adaptive die heating system 22 described in the preceding figures. The method 200 demonstrates the cooperative operation between the PLC 38 and the AI module 42 in predicting, correcting, and continuously improving the heating process through data learning and feedback.

At step 202, the method begins with identification of the specific die to be heated. The die 16 may be detected automatically by an embedded RFID tag or barcode, or its serial number may be selected by the operator through the HMI 40. The PLC 38 retrieves from the recipe management database 60 all historical data and parameters associated with the identified die, including geometry, material composition, mass, prior heating durations, and learned coefficients generated by the AI module 42. The AI module 42 then loads this data and initializes a predictive thermal model that defines an expected temperature-rise trajectory and energy-input pattern tailored to that die 16. Unlike preheating systems of the past that employ fixed time programs, the present system constructs a unique, context aware model before each run, incorporating environmental conditions such as ambient temperature and humidity.

At step 204, predictive heating is initiated. The PLC 38 activates the designated heater (26, 37) and blower 34 under command of the AI module 42, which calculates the optimal distribution of energy between convection and radiant sources where applicable. As heating begins, multiple temperature sensors 48 transmit real-time data to both the PLC 38 and AI 42 module. The AI module 42 is configured to compare the measured rate of temperature increase and spatial uniformity with its predicted model, issuing instantaneous corrective commands to the PLC 38 when deviations exceed tolerance limits. The PLC 38 responds by modulating heater duty cycles, adjusting airflow rate through the VFD 39, or altering the radiant-to-convective energy ratio. These corrections occur continuously, creating a smooth and self-correcting heating curve that converges toward the predicted trajectory.

At step 206, the AI module 42 engages in real-time optimization and learning feedback. Throughout the heating process, the AI module 42 continuously refines its internal model parameters based on incoming sensor data and the observed effectiveness of prior adjustments. A reinforcement-learning algorithm assigns higher reward weights to control actions that reduce total energy usage or time to readiness, enabling the system to recognize and favor more efficient strategies in future runs. If the operator intervenes through the HMI 40 to modify temperature set-points or airflow parameters, the AI module 42 records that action and evaluates its outcome. If the modification leads to improved uniformity or shorter warm-up, the AI module 42 integrates that change into subsequent predictive models, effectively learning from human experience. The HMI 40 displays live comparisons of measured versus predicted temperature curves, an adaptive confidence indicator showing the certainty in the AI model, and a continuously updated readiness forecast.

At step 208, when the AI module 42 determines that the die 16 has reached thermal equilibrium, the system performs readiness verification. The AI module 42 is configured to evaluate the maximum temperature variance among all sensors, the rate of temperature change, and the correlation between measured and modeled curves. When these metrics fall within defined thresholds such as 35 1 °C temperature deviation and ≥0.98 correlation, for example, the AI module 42 is configured to transmit a “ready” signal to the PLC 38. The PLC 38 then transitions the system from full-power heating to hold mode and coordinates with the actuator 30 to transfer the die 16 from the heating position into alignment with the die holder 28 of the extrusion chamber 18. The die 16 can also be moved manually to the die holder 28. The temperature of the die 16 is maintained during transfer, and the extrusion chamber 18 is immediately prepared to begin production, ensuring that the first extruded pasta is dimensionally uniform and consistent in texture.

At step 210, the AI module 42 is configured to conduct post-cycle data logging and model updates. Once the heating sequence is complete and extrusion begins, the AI module 42 aggregates performance data such as total power consumption, heating time, and temperature uniformity values. It then recalculates the coefficients of its predictive model and stores the updated profile back into the recipe management database 60. If the new cycle demonstrates improved efficiency or uniformity, the refined model supersedes previous records for that die. Through this cumulative process, the system becomes progressively more accurate and energy-efficient with continued operation.

At step 212, in embodiments employing plant-wide connectivity, post-cycle data are also transmitted to a cloud analytics server 62 or supervisory control network. There, heating data from multiple machines are aggregated to form a distributed learning base. The cloud system analyzes comparative results, determines optimal parameters across all machines, and propagates updated learning coefficients back to each AI module 42. This federated-learning framework allows improvements achieved on one production line to benefit all other lines using similar dies, producing consistent readiness and performance throughout the entire manufacturing facility.

The adaptive method illustrated in FIG. 7 thus provides a self-improving operational cycle. Each run informs the next, and the system continually optimizes its predictive algorithms, ensuring that every die reaches equilibrium quickly, evenly, and with minimal energy expenditure. The cooperative relationship between the PLC and AI module creates a level of precision and adaptability previously unavailable in die-heating systems, transforming a static preheating step into an intelligent process that learns, predicts, and perfects itself over time.

The combination of features described herein is not a mere aggregation of known heating components but produces a synergistic and non-obvious improvement in pasta-die preheating. Conventional systems rely on timers or fixed PID controls that cannot adapt to environmental or material variation. The present invention introduces machine-learning-driven adaptive control that continuously models, predicts, and refines the heating characteristics of the die. Over successive runs, the system anticipates how each die will respond to given power, airflow, and ambient conditions and automatically implements the control strategies that minimize both heat-up time and energy consumption without human recalibration.

The criticality of this adaptive capability lies in the ability of the system to self-correct and self-improve. The AI module 42 detects deviations from expected behavior, generates corrections in real time, and stores those corrections for future reference thereby creating a closed learning loop. The inclusion of distributed temperature sensors, zoned airflow, and hybrid infrared-convection heating elements allows the AI module 42 to construct a multidimensional thermal model of each die. Without this integrated framework, the observed performance improvements could not be achieved.

The unexpected results obtained include immediate production of dimensionally uniform pasta from the first extrusion cycle, elimination of startup scrap, up to 40 percent reduction in total energy usage, and consistent die readiness within ±1 °C across multiple machines and operating environments. These results could not have been predicted from prior art systems that merely preheated dies in open-loop fashion. The inventive cooperation between the PLC 38 and AI 42 module yields a dynamic control regime that evolves through accumulated experience, providing reproducible, energy-efficient, and operator-independent performance.

Accordingly, the invention provides a new and unobvious approach to industrial pasta die preparation that unites data analytics, adaptive learning, and automated actuation into a self-optimizing process. The synergy of these elements delivers superior temperature stability, energy efficiency, and product consistency that would not be expected from the simple combination of known preheating devices. The described system represents a substantive technological advancement in the automation and intelligence of food-extrusion machinery.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A system for preheating a pasta extrusion die prior to installation in a pasta extruder, comprising:
a hood defining an internal heating chamber configured to receive the pasta extrusion die;
a blower configured to deliver a flow of heated air into the heating chamber;
a heater element positioned to heat the airflow from the blower;
a temperature sensor configured to detect a temperature within the heating chamber;
a programmable logic controller (PLC) configured to control the blower and heater element in response to the detected temperature; and
a user interface configured to display the detected temperature and allow adjustment of a target temperature for die preheating.

2. The system of claim 1, wherein the PLC is configured to control the speed of the blower using a variable frequency drive (VFD) to regulate air flow rate and heat distribution within the heating chamber.

3. The system of claim 1, wherein the PLC executes a stored heating program that defines a time profile for heating based on a stored identifier corresponding to the pasta extrusion die.

4. The system of claim 3, wherein the identifier corresponds to a serial number of the die stored within a recipe management system associated with the pasta extruder.

5. The system of claim 3, wherein the PLC automatically selects heating parameters including temperature setpoint, airflow rate, and heating duration based on stored data associated with the die identifier.

6. The system of claim 1, further comprising an infrared heating unit positioned within the hood and operable under control of the PLC as an alternative or supplemental heat source.

7. The system of claim 1, wherein the user interface comprises a human machine interface (HMI) configured to display at least one of: a real-time temperature reading, fan speed, and remaining heating time.

8. The system of claim 1, wherein the PLC stores a plurality of heating profiles each associated with a corresponding type of pasta extrusion die.

9. The system of claim 8, wherein the heating profile includes parameters derived from prior production runs of the same die type.

10. The system of claim 1, wherein the blower and heater element are positioned within the hood to produce uniform air circulation around the pasta extrusion die.

11. The system of claim 1, further comprising an artificial intelligence (AI) module configured to monitor heating performance and adjust one or more control parameters based on historical data or predicted heat-up behavior of the die.

12. The system of claim 11, wherein the AI module employs a machine learning model trained to predict optimal heating duration and airflow rate based on die geometry, mass, and material composition.

13. The system of claim 11, wherein the AI module continuously updates the heating profile for a given die identifier by learning from temperature sensor feedback and operator adjustments.

14. The system of claim 11, wherein the AI module interfaces with the recipe management system of the pasta extruder to refine heating parameters for future runs.

15. The system of claim 11, wherein the AI module utilizes reinforcement learning to minimize startup waste by iteratively optimizing heating time and temperature uniformity across multiple production cycles.

16. A method of preheating a pasta extrusion die prior to installation in a pasta extruder, comprising:
placing the die within a hood defining a heating chamber;
activating a blower and heater under control of a PLC;
monitoring a temperature within the chamber via a temperature sensor;
adjusting a fan speed and heater output to achieve a predetermined temperature profile; and
signaling, via a user interface, that the die has reached a target temperature suitable for extrusion.

17. The method of claim 16, further comprising retrieving, by the PLC, heating parameters associated with a die identifier from a stored recipe management system and executing a corresponding heating cycle.

18. The method of claim 16, further comprising analyzing temperature feedback data with an AI module to modify subsequent heating profiles for improved uniformity and reduced heat-up time.

19. The method of claim 18, wherein the AI module predicts a heat-up curve for a specific die geometry and material composition to determine an optimal control sequence for the blower and heater.

20. A non-transitory computer-readable medium storing instructions which, when executed by a processor, cause a system to perform the steps of claim 16.
